(19) United States
(12) Patent Application Publication
(10) Pub. No.: US 2024/0406628 A1
(43) Pub. Date: Dec. 5, 2024

(54) COLLABORATIVE CONTROL FOR ELECTRONIC DEVICES

(71) Applicant: Apple Inc., Cupertino, CA (US)

(72) Inventors: Cesar DE CAMARGO BARSCEVICIUS, San Jose, CA (US); Adam Y. SYED, San Francisco, CA (US); Alejandro A. RODRIGUEZ, Saratoga, CA (US); Brandon CHESTER, San Jose, CA (US); Duy N. PHAN, Los Gatos, CA (US); Jota MELO MIRANDA FAGUNDES ANTUNES, Santa Clara, CA (US); Justin R. ETZINE, San Jose, CA (US); Rahul SARNA, Sunnyvale, CA (US); Shannon SHIH, Mountain View, CA (US); Victor Gabriel MARACCINI, Santa Clara, CA (US)

(21) Appl. No.: 18/677,795

(22) Filed: May 29, 2024

Related U.S. Application Data
(60) Provisional application No. 63/470,815, filed on Jun. 2, 2023.

(51) Int. Cl. H04R 3/04; H04B 5/77

(52) U.S. Cl. CPC H04R 3/04; H04B 5/77

(57) ABSTRACT

Implementations of the subject technology provide systems and methods for providing collaborative control by multiple electronic devices. Collaborative control may include providing, by a first device that is outputting content, such as audio content, an invitation to a second device to control the content that is being output by the first device. The content may be being output by the first device directly, or via a third device, such as a media output device. The media output device may be a speaker, a television, or other media output device. The second device may be provided with the ability to control the output of the first device while in proximity to the first device and/or the media output device. Control commands from the second device for controlling the output of the first device may be provided to the first device over a network.

### CROSS REFERENCE TO RELATED APPLICATIONS

This application claims the benefit of priority to U.S. Provisional Patent Application No. 63/470,815, entitled, “COLLABORATIVE CONTROL FOR ELECTRONIC DEVICES”, filed on Jun. 2, 2023, the disclosure of which is hereby incorporated herein in its entirety.

### TECHNICAL FIELD

The present description relates generally to electronic devices including, for example, to collaborative control for electronic devices.

### BACKGROUND

Electronic devices often include applications for outputting media content. The media content can be provided by a server that provides a media service to which an electronic device is subscribed. In some systems, when two electronic devices are subscribed to the same service, the server can provide synchronized media content to both of the electronic devices, for synchronized output by both of the electronic devices.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example system architecture including various electronic devices that may implement the subject system in accordance with one or more implementations.

FIG. 2 is a schematic diagram illustrating an electronic device inviting another electronic device to control a collaborative session, in accordance with implementations of the subject technology.

FIG. 3 is a schematic diagram illustrating an electronic device controlling content being output by another electronic device via a separate media output device, in accordance with implementations of the subject technology.

FIG. 4 illustrates an example of an electronic device providing options for inviting nearby electronic devices to control a collaborative session in accordance with implementations of the subject technology.

FIG. 5 illustrates an example of an electronic device storing trusted contacts in accordance with implementations of the subject technology.

FIG. 6 illustrates an example of messaging operations that can indicate a trusted contact in accordance with implementations of the subject technology.

FIG. 7 illustrates an example of call operations that can indicate a trusted contact in accordance with implementations of the subject technology.

FIG. 8 illustrates a schematic diagram illustrating a media output device displaying attribution information for content being output by the media output device, in accordance with implementations of the subject technology.

FIG. 9 illustrates a flow diagram for an example process for providing a nearby device invitation to a collaborative session in accordance with implementations of the subject technology.

FIG. 10 illustrates a flow diagram for an example process for accepting a nearby device invitation to a collaborative session in accordance with implementations of the subject technology.

FIG. 11 illustrates a flow diagram for providing collaborative control of a collaborative session to another electronic device in accordance with implementations of the subject technology.

FIG. 12 illustrates a flow diagram for an example process for controlling a collaborative session associated with another electronic device in accordance with implementations of the subject technology.

FIG. 13 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Electronic devices often include applications for outputting media content, editing documents, displaying maps and/or directions, and/or sharing content. In some systems, multiple electronic devices can be each subscribed to the same service provided by a server, and the server can synchronize the data at each of the multiple electronic devices, so that each of the multiple electronic devices can display or otherwise output the same, synchronized content. For example, multiple electronic devices can each play the same movie or the same song in synchronization, as coordinated by a media content server. This can allow users of electronic devices in remote locations to share a media experience. As another example, multiple electronic devices can collaboratively edit a common electronic document stored at the server or locally at one or more of the multiple electronic devices, with updates to the documents at each device coordinated by the server.

However, in some scenarios, one or more of multiple devices for which collaborative control is desired may not have a subscription to a service provided by a server that can coordinate data for the multiple devices. In some scenarios, multiple devices may be within a physical proximity to each other, and output of content individually by multiple devices may not be desirable. For example, multiple users of multiple devices may desire to collaboratively listen to music or podcasts, or collaboratively watch video content, on a common media output device, such as a speaker or a television (e.g., that is not connected to the server or subscribed to a service). In these and other scenarios, the proximity of the devices can be used as an indication of trust, to facilitate collaborative control by the devices.

Aspects of the disclosure may provide for invitations provided to proximate or nearby electronic devices (e.g., nearby device invitations, or nearby invitations), such as invitations to collaborative sessions. Aspects of the subject technology may provide an electronic device with the ability to share, with other proximate devices, control of a collaborative session, such as for control of media output from the device or for control of editing, contributing to, and/or changing data (e.g., a collaborative document) by multiple users from multiple respective devices. In this way, the subject technology can facilitate multiple devices controlling the output of a media output device (e.g., a speaker, a television, or the like), such as for a group of people listening to audio content via a speaker in a vehicle, a group of people listening to audio content via a speaker in a building (e.g., during a party), or a group of people listening to audio content via a portable wireless speaker (e.g., at the beach, at the park, on a boat, in a campground, etc.).

In one or more implementations, a first device can provide an invitation directly (e.g., via Bluetooth or other short-range wireless communication protocol) to one or more proximate devices to control media content that the first device is outputting, such as via a media output device (e.g., a portable Bluetooth speaker, a car speaker, a home speaker, etc.) that is separate from the first device. One or more of the proximate devices can accept the invitation, and can then control the media content being output by the first device over a network such as via a server that manages the collaborative session. In various implementations, the invitation can be provided wirelessly to nearby trusted contacts, via a scannable code, and/or responsive to a user request to invite all nearby devices. The invitation can be provided without revealing the identity of the user of the first device. The invitation can be provided to a device, and accepted by the device, whether or not the device has access to a subscription to the media content.

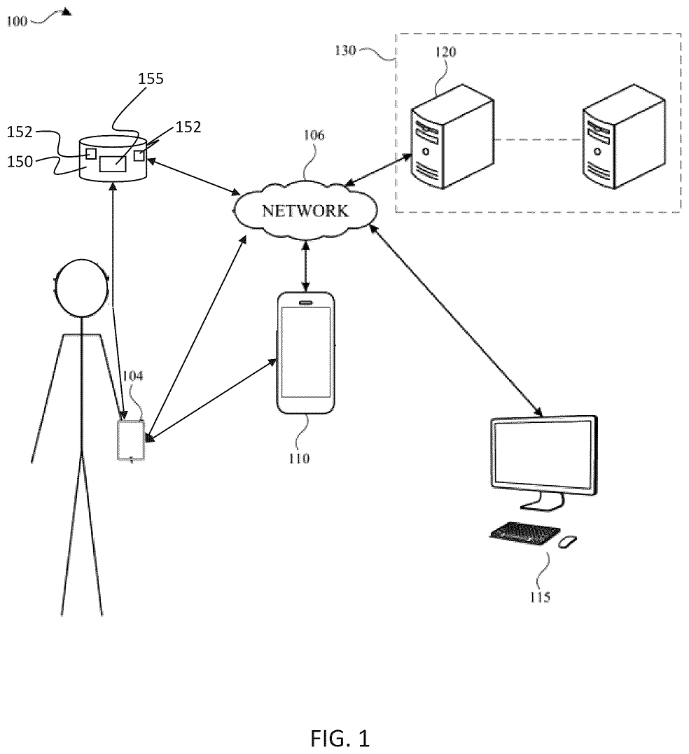

FIG. 1 illustrates an example system architecture 100 including various electronic devices that may implement the subject system in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The system architecture 100 includes a media output device 150, an electronic device 104 (e.g., a handheld electronic device such as a smartphone or a tablet), an electronic device 110, an electronic device 115, and a server 120 communicatively coupled by a network 106 (e.g., a local or wide area network). For explanatory purposes, the system architecture 100 is illustrated in FIG. 1 as including the media output device 150, the electronic device 104, the electronic device 110, the electronic device 115, and the server 120; however, the system architecture 100 may include any number of electronic and/or audio devices and any number of servers or a data center including multiple servers.

The media output device 150 may be implemented as an audio output device such as a speaker (e.g., a wireless speaker such as Bluetooth speaker, a smart speaker, a portable speaker, or a speaker mounted in a fixed or movable structure), a set top box, a television, or may be implemented as any other device capable of outputting audio, video and/or other types of media. As shown, the media output device 150 may include one or more speakers 152. In one or more implementations, the media output device 150 may include or be associated with a display, such as display 155. The display 155 may be integrally formed with the media output device 150 (e.g., mounted in a housing or other structure of the media output device) implemented in a housing that is physically separate from the media output device. In one or more implementations, the media output device 150 may be implemented as, or may be incorporated into, a larger device or system, such as a vehicle (e.g., a car, a bus, an airplane, a boat, a helicopter, or any other land, air, or water craft) or a building (e.g., a home, an office, a hotel, or the like).

Although not visible in FIG. 1, in one or more implementations, the media output device 150 may include processing circuitry (e.g., including memory and/or one or more processors, such as a central processing unit and/or one or more digital signal processors (DSPs)) and communications circuitry (e.g., one or more antennas, etc.) for receiving and/or processing audio content from one or more of the electronic device 104, the electronic device 110, the electronic device 115, and/or the server 120. The processing circuitry of the media output device 150 or another device may operate one or more speakers, such as the speakers 152, to generate the sound.

The media output device 150 may include communications circuitry for communications (e.g., directly or via network 106) with the electronic device 104, the electronic device 110, the electronic device 115, and/or the server 120, the communications circuitry including, for example, one or more wireless interfaces, such as WLAN radios, cellular radios, Bluetooth radios, Zigbee radios, near field communication (NFC) radios, and/or other wireless radios. The electronic device 104, the electronic device 110, an electronic device 115, and/or the server 120 may include communications circuitry for communications (e.g., directly or via network 106) with media output device 150 and/or with the others of the electronic device 104, the electronic device 110, the electronic device 115, and/or the server 120, the communications circuitry including, for example, one or more wireless interfaces, such as WLAN radios, cellular radios, Bluetooth radios, Zigbee radios, near field communication (NFC) radios, and/or other wireless radios. The media output device may include a power source such as a battery and/or a wired or wireless power source.

As shown, the media output device 150 may communicate directly with an electronic device, such as the electronic device 104 (e.g., to receive audio content for output by the speaker(s) 152 and/or to receive display content for display by the display 155). In one or more implementations, the media output device 150 may be configured for direct communication with electronic devices using a short-range communication protocol (e.g., a Bluetooth, Zigbee, or near field communication (NFC) protocol), and may be unable to communicate over a wider area network, such as the network 106.

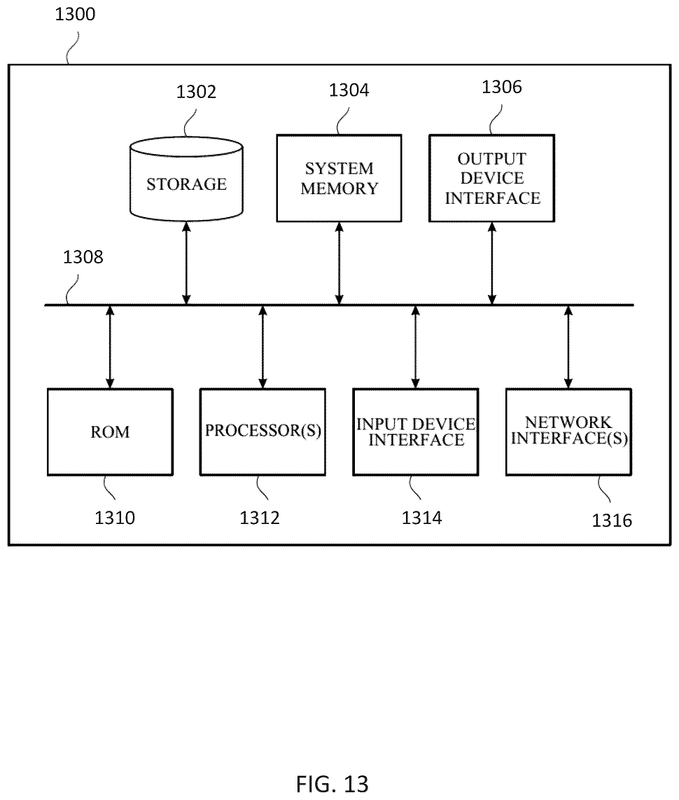

As shown, the electronic device 104 may communicate with one or more other electronic devices, such as the electronic device 110, directly (e.g., using a short-range communication protocol such as a Bluetooth, Zigbee, or near field communication (NFC) protocol) and/or over a network, such as the network 106. The electronic device 104 may be, for example, a smartphone, a portable computing device such as a laptop computer, a peripheral device (e.g., a digital camera, headphones, another audio device, or another media output device), a tablet device, a wearable device such as a smart watch, a smart band, and the like, any other appropriate device that includes, for example, processing circuitry and/or communications circuitry for providing audio content to media output device(s) 150. In FIG. 1, by way of example, the electronic device 104 is depicted as a mobile smartphone device. In one or more implementations, the electronic device 104 and/or the media output device 150 may be, and/or may include all or part of, the electronic system discussed below with respect to FIG. 13.

The electronic device 115 may be, for example, desktop computer, a portable computing device such as a laptop computer, a smartphone, a peripheral device (e.g., a digital camera, headphones, another audio device, or another media output device), a tablet device, a wearable device such as a watch, a band, and the like. In FIG. 1, by way of example, the electronic device 115 is depicted as a desktop computer. The electronic device 115 may be, and/or may include all or part of, the electronic system discussed below with respect to FIG. 13.

The electronic device 110 may be, for example, desktop computer, a portable computing device such as a laptop computer, a smartphone, a peripheral device (e.g., a digital camera, headphones, another audio device, or another media output device), a tablet device, a wearable device such as a watch, a band, and the like. In FIG. 1, by way of example, the electronic device 115 is depicted as a smartphone. The electronic device 110 may be, and/or may include all or part of, the electronic system discussed below with respect to FIG. 13.

The server 120 may form all or part of a network of computers or a group of servers 130, such as in a cloud computing or data center implementation. For example, the server 120 stores data and software, and includes specific hardware (e.g., processors, graphics processors and other specialized or custom processors) for rendering, generating, and/or distributing content such as graphics, images, video, audio and multi-media files. In an implementation, the server 120 may function as a cloud storage server.

In one or more implementations, the servers 130 may include servers operated by different entities. For example, the servers 130 may include a media content server that provides media content (e.g., music, podcasts, radio content, movies, and/or other content) over the network 106 to electronic devices, such as the electronic device 104, the electronic device 110, and/or the electronic device 115. In one example use case, the electronic device 104 may obtain media content over the network 106 from a media content server and provide the media content directly to the media output device 150. In another example use case, the electronic device 104 may provide media content directly to the media output device 150 from local storage (e.g., a media library) at the electronic device 104. As another example, the servers 130 may include servers that provide identity and/or authentication services, and/or servers that manage collaborative sessions (e.g., collaborative sessions for media content output, document editing, electronic conferencing, mapping and directions, calendaring, vehicle management, or the like) among multiple electronic devices.

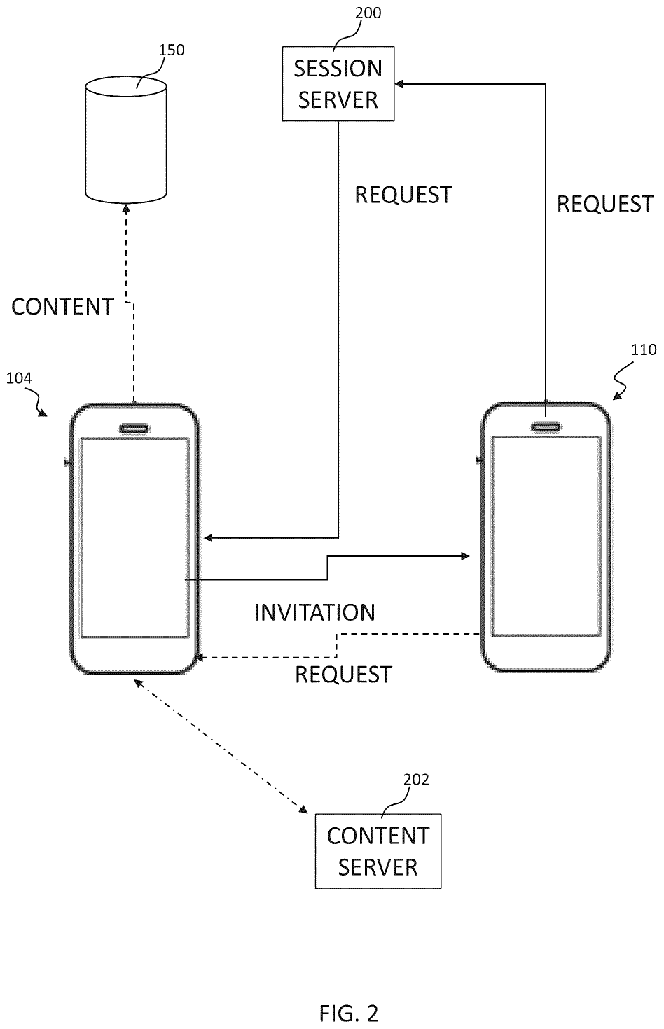

FIG. 2 is a schematic diagram that illustrates various aspects and/or operations that may be performed for providing an invitation (e.g., to a collaborative session) to another electronic device, according to aspects of the disclosure. As illustrated in FIG. 2, the electronic device 104 may provide an invitation directly to the electronic device 110. For example, the invitation may be an invitation to join and/or control a collaborative session with the electronic device 104. For example, the invitation may be an invitation to control content that is being output by the electronic device 104 via the media output device 150. For example, the electronic device 104 may be providing audio content to the media output device 150 for output by the speakers 152 of the media output device 150.

In one or more implementations, the invitation may be provided from the electronic device 104 to the electronic device 110 when the electronic device 110 is within proximity of the electronic device 104 (e.g., within a range of a short-range communication protocol). In one example, the electronic device 104 may detect the presence of the electronic device 110 in proximity to the electronic device 104, determine that the electronic device 110 is associated with a trusted contact stored at the electronic device 104, and provide the invitation to the electronic device 110 responsively. In another example, the electronic device 104 may periodically provide encrypted invitations to join a collaborative session, in which the encrypted invitations can only be decrypted by trusted contacts of the electronic device 104. In yet another example, the user of the electronic device 104 may provide a user input to the electronic device 104, the user input including a request to invite all nearby devices to join a collaborative session. In this example, the invitation may be an unencrypted invitation that can be accepted by any device within range of the communication protocol by which the invitation is broadcast.

As shown in FIG. 2, responsive to receiving the invitation, the electronic device 110 may provide a request to join the collaborative session to the electronic device 104. As shown in FIG. 2, the request may be provided from the electronic device 110 to the electronic device 104 directly (e.g., via a short-range wireless communication, such as a Bluetooth communication), or over a network, such as via a session server 200. For example, the session server 200 may be an implementation of one of the servers 130 of FIG. 1. As shown, electronic device 110 may provide the request to the session server 200, and the session server 200 may forward the request to the electronic device 104. In one or more implementations, responsive to receiving the request from the electronic device 110, the electronic device 104 may provide an authorization for the electronic device 110 to join the collaborative session, and/or to control the collaborative session. The authorization may be provided directly from the electronic device 104 to the electronic device 110, or via the session server 200. For example, controlling the collaborative session may include controlling the output of the electronic device 104 (e.g., including controlling the content that is being output by the electronic device 104, such as via the media output device 150). The authorization may be provided from the electronic device 104 to the session server 200. The session server 200 may provide an indication of the authorization to the electronic device 110.

In one or more implementations, the electronic device 104 may provide the authorization for the electronic device 110 to join the collaborative session based, in part, on a proximity of the electronic device 110 to the electronic device 104 and/or the media output device 150. In one example, the electronic device 104 can determine that the electronic device 110 is in proximity to the electronic device 104 by exchanging the invitation and the request directly, using a short-range communication protocol. In another example, the electronic device 110 may provide proximity confirming information to the electronic device 104. For example, the electronic device 110 may obtain (e.g., using a microphone of the electronic device 110) a recording (e.g., a recording of a few seconds, one second, or less than one second) of the acoustic environment of the electronic device 110 (e.g., including a recording of audio content being output by the electronic device 104 via the media output device 150). The electronic device 110 may hash, encrypt, and/or otherwise encode the recorded audio, and provide the hashed, encrypted, and/or otherwise encoded audio to the electronic device 104.

The electronic device 104 may compare the hashed, encrypted, and/or otherwise encoded audio received from the electronic device 110 with hashed, encrypted, and/or otherwise encoded audio obtained locally by the electronic device 104 (e.g., using or more microphones of the electronic device 104), and may determine that the electronic device 110 is proximate to the electronic device 104 and/or the media output device 150 if the hashed, encrypted, and/or otherwise encoded audio received from the electronic device 110 matches the hashed, encrypted, and/or otherwise encoded audio obtained locally by the electronic device 104. For example, in this way, the electronic device 104 (and/or the electronic device 110) can confirm that the electronic device 104 and the electronic device 110 are in the same acoustic environment (e.g., within an audible range of each other and/or of the media output device). For example, this type of audio-based proximity verification can be used to confirm that the electronic device 110 is near enough to the media output device 150 for a user of the electronic device 110 to hear the audio content being output by the media output device 150.

In one or more implementations, the invitation may be provided without any identifying information of the electronic device 104 or the user of the electronic device 104. For example, in a use case in which the invitation is an encrypted invitation, the invitation may be encrypted, by the electronic device 104, using a key that was previously configured between the electronic device 104 and the electronic device 110. In this way, when the electronic device 110 receives the encrypted invitation, the electronic device 110 can decrypt the invitation using the previously configured key. In this example, the electronic device 110 may store multiple keys corresponding to multiple contacts.

In one or more implementations, the electronic device 110 may perform identification operations using the keys for the multiple contacts, to identify one of the keys that corresponds to a particular trusted contact. For example, the encrypted invitation may include an unencrypted value, such as a random number or a short-range communications address of the electronic device 104 (e.g., which may be periodically updated to prevent tracking of the electronic device 104), and an unencrypted hash of the value calculated using a key corresponding to the electronic device 104. The electronic device 110 can hash the value with each of the keys for each of the multiple contacts stored locally thereon until a hash of the value with a particular key matches the hashed value in the invitation. When the electronic device 110 determines that one of the keys, when hashed with the value in the encrypted invitation, matches the hash of the value and the key in the encrypted invitation, the electronic device 110 can identify the contact corresponding to the electronic device 104 as the contact corresponding to that key. In one or more implementations, the identified key may be used to decrypt a payload included in the encrypted invitation. For example, the payload may include a session identifier for the collaborative session associated with the electronic device 104.

Using the identified key, the electronic device 110 can also obtain contact information, previously stored at the electronic device 110, for the electronic device 104. In one or more implementations, the electronic device 110 may include that contact information in the request provided to the session server 200. The session server 200 can then forward the request (e.g., along with a session identifier) to the electronic device 104 using the contact information provided by the electronic device 110. In this way, the privacy of the user of the electronic device 104 can be protected, while still providing the ability to invite nearby devices to join and/or control a collaborative session.

In another example use case, in which the user of the electronic device 104 requests that an invitation to a collaborative session be sent to all nearby devices, the invitation may be an unencrypted invitation. In this example use case, the electronic device 104 may include an obfuscated identifier for the electronic device in the invitation (e.g., along with a session identifier for the collaborative session). For example, the obfuscated identifier may be obtained by the electronic device 104 specifically for a collaborative session, and the obfuscated identifier may not include any information identifying the user of the electronic device 104. When the electronic device 110 receives an unencrypted invitation including an obfuscated identifier, the electronic device 110 can include the obfuscated identifier in the request to the session server 200. In more and more implementations, the obfuscated identifier may have been previously configured between the electronic device 104 and the session server 200, and the session server 200 may have previously stored the obfuscated identifier in connection with contact information for the electronic device 104.

When the session server 200 receives the request including the obfuscated identifier from the electronic device 110, the session server can use the obfuscated identifier to look up the contact information for the electronic device 104, and can forward the request to the electronic device 104 using the obtained contact information. In this way, the privacy of the user of the electronic device 104 can be protected from being revealed to the electronic device 110, while still allowing the electronic device 104 to invite the electronic device 110 to join a collaborative session associated with the electronic device 104. As discussed in further detail hereinafter, an invitation may be provided to the electronic device 110 in other ways, such as by displaying a scannable code using a display of the electronic device 104, and scanning the scannable code using the electronic device 110 (e.g., a barcode, QR code, etc.). For example, the scannable code may include an encoded obfuscated identifier for the electronic device 104, which can be used by the electronic device 110 to generate a request and/or a control command for the session server 200.

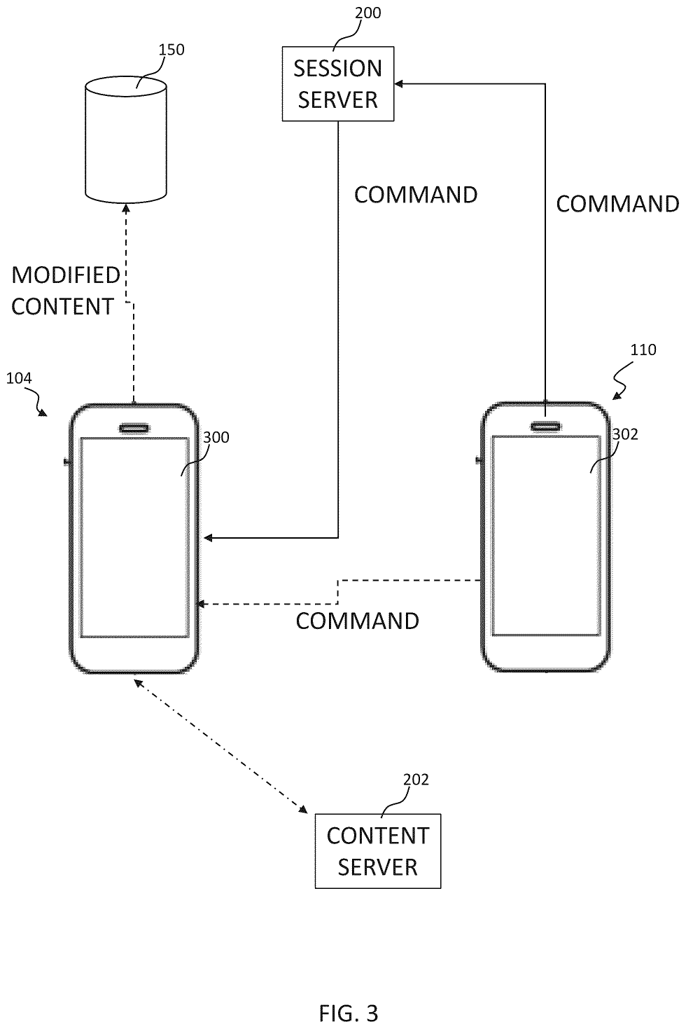

FIG. 3 is a schematic diagram that illustrates various aspects and/or operations that may be performed for controlling, by the electronic device 110, a collaborative session with the electronic device 104, according to aspects of the disclosure. For example, after the electronic device 110 has been authorized to join the collaborative session (as in FIG. 2), the electronic device 110 may provide a command (e.g., a control command) to the electronic device 104. As shown, the electronic device 110 may provide the command to the electronic device 104 via the session server 200 (e.g., over the network 106). In one or more other implementations, the electronic device 110 may provide the command to the electronic device 104 directly. As shown, the command may be a control command to modify the content being output by the electronic device 104 (e.g., via the media output device 150). For example, the control command may be generated by the electronic device 110 responsive to a user input to the electronic device 110 (e.g., from a user of the electronic device 104 via a touch surface, a mouse, a button, a switch, a touchscreen, a camera, a sensor, and/or a microphone of the electronic device 104), the user input including a user input to modify the content being output by the electronic device 104.

As shown, responsive to the command from the electronic device 110, the electronic device 104 may modify the content being provided to the media output device 150 for output (e.g., by the speakers 152 and/or display 155 of the media output device 150). As examples, modifying the content may that is being output by the electronic device 104 via the media output device 150 may include selecting a new song, skipping to a next or previous song, scrolling to a new playback time of a song, a podcast, a movie, a show, or other media content, stopping playback, starting playback, pausing playback, or adding or removing a song from a playlist. As another example, modifying the content may that is being output by the electronic device 104 via the media output device 150 may include controlling a video conferencing session for which audio and/or video is being output by the media output device. As another example, modifying the content may that is being output by the electronic device 104 via the media output device 150 may include entering or modifying input to a mapping application for providing visual and/or audible directions using the media output device 150. In one or more other implementations, responsive to the command from the electronic device 110, the electronic device 104 may modify content being output directly by the electronic device 104 (e.g., by the display 300 of the electronic device 104). As examples, modifying the content that is being output directly by the electronic device 104 may include modifying a document or other data being displayed by the electronic device 104.

In one or more implementations, when the command is received at the electronic device 104, the electronic device 104 may process the command as if the command were received as a direct user input to the electronic device 104 (e.g., from a user of the electronic device 104 via a touch surface, a mouse, a button, a switch, a touchscreen, a camera, a sensor, and/or a microphone of the electronic device 104). For example, after being authorized to join a collaborative session, a user interface (UI) may be displayed by a display 302 of the electronic device 110 that includes substantially the same information and/or control elements that are displayed by a UI of the electronic device 104 for controlling the output (e.g., for controlling the output of the content by the media output device 150). For example, the electronic device 104 may have an installed application (e.g., a media player application, a data editing application, a conferencing application, a mapping application, etc.) for controlling the output of the electronic device 104 (e.g., directly or via the media output device 150).

In some use cases, the electronic device 110 may also have the application installed and, upon authorization to join the collaborative session, may be provided, by the session server 200, with information for populating the UI of the application at the electronic device 110 to display substantially the same information displayed by the UI of the application at the electronic device 104. In this way, the electronic device 110 can present content information about the content being output by the electronic device 104, and operate the same control elements (e.g., a play button, a stop button, a pause button, a volume control, a scrub bar, a text input field, a search field, a playlist creation controller, a playlist modification controller, or the like) that are provided by the electronic device 104. In this way, the user of the electronic device 110 can operate the control element of the application at the electronic device 110 to control the output of the electronic device 104 (e.g., via the media output device 150).

In one or more other use cases, the electronic device 110 may not have the application installed thereon, and may access a web-based version of the user interface (e.g., hosted by the session server 200 or the content server 202). For example, the web-based version of the user interface may be populated, by the session server and/or the content server 202, for displaying substantially the same information and/or control elements displayed by the user interface of the application at the electronic device 104. In one or more other use cases, the electronic device 110 may not have the application installed thereon, and may obtain, for the collaborative session, a reduced version of the application (e.g., a clip of the application) that can be run at the electronic device 110 immediately (e.g., without installing the reduced version of the application at the electronic device 110). For example, the reduced version of application may display a user interface that may be populated, by the session server and/or the content server 202, for displaying substantially the same information and/or control elements displayed by the user interface of the application at the electronic device 104.

In one or more implementations, the electronic device 104 may have access to a subscription to a service provided by the content server 202. In the example of FIGS. 2 and 3, the electronic device 110 that is invited, by the electronic device 104, to control the output of the electronic device 104 may, or may not, have access to a subscription to the service that is provided by the content server 202. However, even in use cases in which the electronic device 110 does not have access to a subscription to the service provided by the content server 202, the electronic device 110 can still, using the operations described in connection with FIGS. 2 and 3, join a collaborative session with the electronic device 104 and control the output of the electronic device 104 that is generated using the subscription to which the electronic device 104 has access.

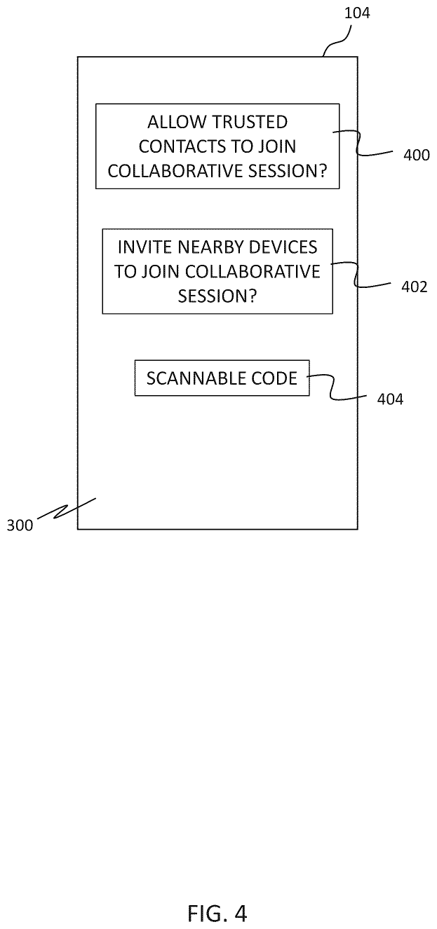

As discussed herein in connection with the example of FIGS. 2 and 3, the invitation from the electronic device 104 can be provided in various ways. For example, FIG. 4 illustrates example options that can be provided, by the electronic device 104 to a user of the electronic device 104, for inviting other devices to join a collaborative session. As shown, the electronic device 104 may provide a user-selectable option 400 to allow trusted contacts to join a collaborative session. When selected, the user-selectable option 400 may cause the electronic device 104 to periodically broadcast an encrypted invitation that is encrypted using information that is known at one or more devices of one or more trusted contacts that are stored at the electronic device 104. In the example of FIG. 4, the electronic device 104 also provides a user-selectable option 402 to invite nearby devices to join a collaborative session. For example, when selected, the user-selectable option 402 may cause the electronic device 104 to broadcast an unencrypted invitation to a collaborative session to nearby devices, such as by using a short range communication protocol. As shown in FIG. 4, electronic device 104 may also, or alternatively, provide a scannable code 404 that can be used for joining a collaborative session. For example, the scannable code 404 may include an encoded identifier of the collaborative session, and an encoded obfuscated identifier of the electronic device 104, as discussed herein. In one or more implementations, the scannable code 404 may be displayed on the display 155 of the electronic device 104, and can be scanned, for example, using a camera of another electronic device, such as the electronic device 110. It is appreciated that a scannable code 404 may be used to invite any other device with the capability of scanning and interpreting the scannable code 404 (e.g., including devices that are not associated with contacts stored at the electronic device 104, devices associated with stored contacts at the electronic device 104, and/or devices of trusted contacts).

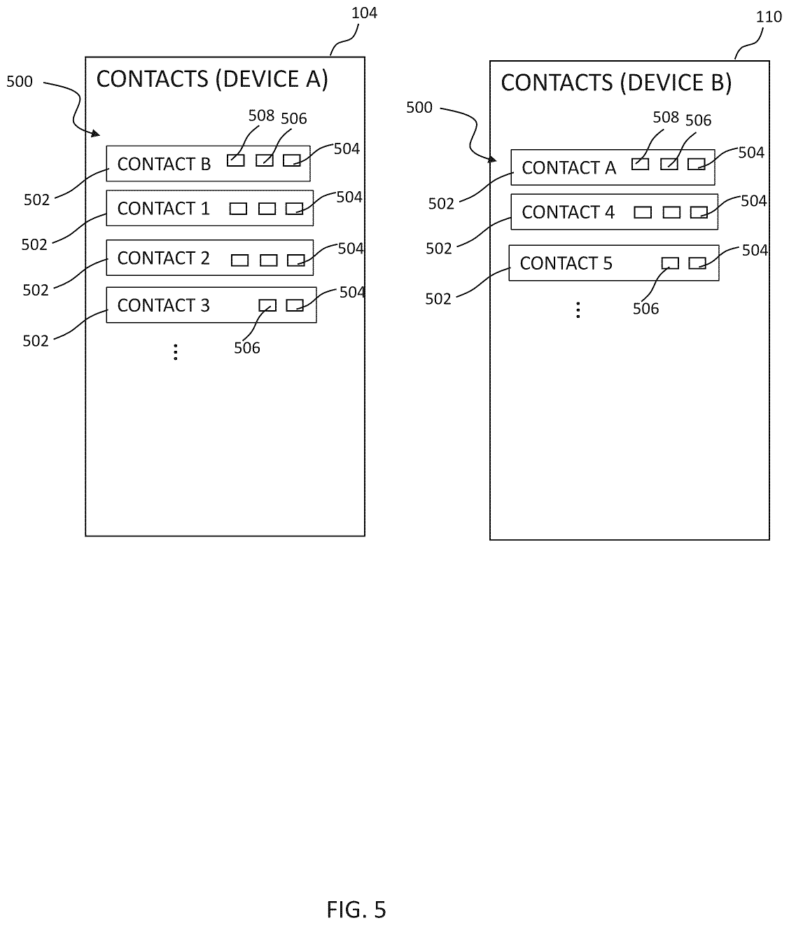

FIG. 5 illustrates an example of trusted contacts that may be stored at an electronic device, such as the electronic device 104. As shown in FIG. 5, a list 500 of contacts 502 can be stored at the electronic device 104. As shown, each of the contacts 502 that are trusted contacts may be stored along with a respective key 504 (e.g., an identity resolving key, or IRK, which may be a symmetric key that is stored at both the electronic device 104 and the device of the corresponding contact 502, or public key of a public key/private key pair for which the private key is stored at the device of the corresponding contact 502). For example, each key 504 may be an encryption key that has been configured in cooperation with an electronic device of the respective contact for which that key is stored. For example, configuring a key 504 may include storing a copy of the key 504 at the electronic device 104 in association with a respective contact (e.g., contact B, corresponding to electronic device 110) of another electronic device (e.g., electronic device 110), and storing the same key 504 (or a complementary key) at the other electronic device (e.g., in association with a contact 502 for a respective contact, such as contact A, corresponding to the electronic device 104). As shown, each of the contacts 502 may also include contact information 506 for the respective contact.

In one or more implementations, the invitation that is provided to the electronic device 110 by the electronic device 104 may include a value (e.g., a short-range communications address of the electronic device 104), and a hash of the value with a key 504 of a particular contact 502 (e.g., contact B in the example of FIG. 5). In these implementations, the electronic device 110 may identify the electronic device 104 by hashing the value received in the invitation with one or more keys 504 that are stored at the electronic device 110 in connection with one or more respective contacts 502 at the electronic device 110, including a contact (e.g., contact A in the example of FIG. 5) for the electronic device 104. The electronic device 110 may identify the contact corresponding to the electronic device 104 by identifying the hash of the value with one plurality of keys that matches the hashed value in the invitation from the electronic device 104. In this way, the key 504 used to generate the hashed value in the invitation can be identified, and the contact 502 for which that key 504 is stored can also be identified. Once the contact 502 corresponding to a key 504 is identified, contact information 506 for the electronic device 104 may be obtained from the information that is stored locally (e.g., in the list 500) at the electronic device 110. For example, the contact information 506 may include a telephone number, an email address, or any other (e.g., alphanumeric) identifier of the electronic device 104. As shown, one or more of the contacts 502 stored at the electronic device 104 may have user information 508 for a user corresponding to that contact. As examples, the user information 508 may include a name, a picture, an avatar, or the like.

In one or more implementations, a key 504 may be configured for a contact 502 stored by the electronic device 104 when the contact is determined to be a trusted contact. In one or more implementations, contacts stored at the electronic device 104 may be determined to be trusted contacts in various ways. As an example, the contact may be determined, by the electronic device 104, to be a trusted contact, when a user of the electronic device 104 identifies a contact as being a member of a trusted group, such as a family, a friend group, a coworker group, or another group that is registered, for example, at a remote server. As another example, the contact may be determined, by the electronic device 104, to be a trusted contact, when a user of the electronic device 104 stores the contact in a contact list (e.g., in an electronic address book) at the electronic device 104. For example, storing the contact in the contact list may include adding a name, a picture, an avatar, or other identifying information to the contact, along with the contact information 506.

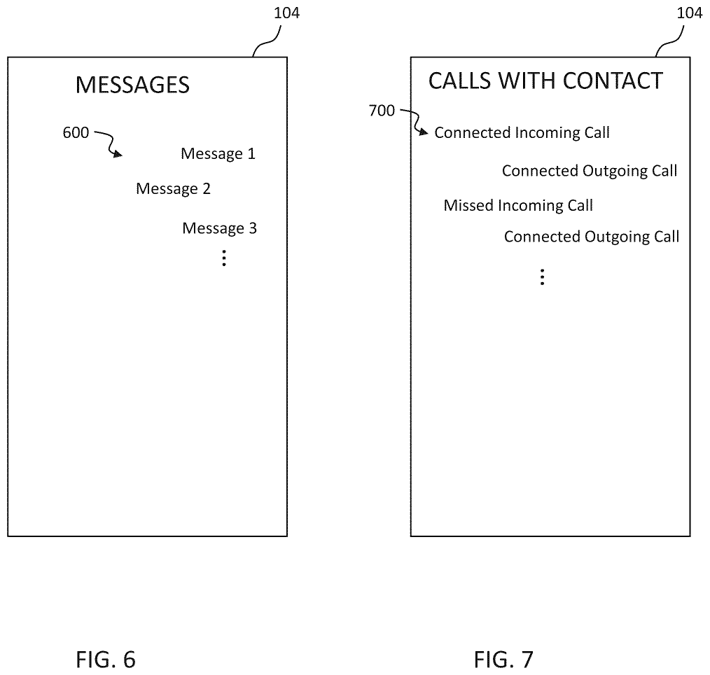

As another example, a contact may be determined, by the electronic device 104, to be a trusted contact based on a communication history between the electronic device 104 and an electronic device associated with the contact. For example, FIG. 6 illustrates a message thread 600 that includes two way (e.g., bidirectional) messaging communication between the electronic device 104 and another electronic device. In the example of FIG. 6, electronic device 104 may determine that the contact corresponding to the message thread 600 is a trusted contact when at least one message is sent from electronic device 104 to the electronic device corresponding with the contact (e.g., a contact that sends a single message to the electronic device to 104, to which no response is sent from the electronic device 104, may not be determined to be a trusted contact). FIG. 7 illustrates another example in which a call list 700 is shown. In the example of FIG. 7, the call list 700 includes incoming calls from another electronic device associated with a contact, and outgoing calls from the electronic device to the other electronic device associated with the contact. In one or more implementations, the electronic device 104 may determine that a contact is a trusted contact when at least one incoming call is answered by a user of the electronic device 104, or when both an incoming call and an outgoing call (e.g., two-way, or bidirectional communications) have been connected. The calls of FIG. 7 may be telephone calls, audio conferences, and/or video conferences between the electronic device 104 and the other electronic device.

In one or more implementations, a contact may be determined, by the electronic device 104, to be a trusted contact based on storage of the contact 502 in a contacts list 500, and at least one bi-directional communication with the contact. In one or more implementations, a contact may be determined, by the electronic device 104, to be a trusted contact based on storage of the contact 502 for the contact in a contacts list 500, storage of contact information for the electronic device 104 at a device (e.g., electronic device 110) of the contact, and at least one bi-directional communication with the contact.

As another example, a contact may be determined, by the electronic device 104, to be a trusted contact based on an extreme proximity interaction between the electronic device 104 and an electronic device of the contact (e.g., by tapping the electronic device of the contact and the electronic device 104 together), which may cause an NFC exchange of keys 504 between the devices. As another example, a trusted contact status can be synchronized across multiple electronic devices associated with the same user account (e.g., a smartphone, a smartwatch, a tablet device, a laptop, and/or one or more other devices associated with the same user).

As discussed herein, during a collaborative session (e.g., and while the electronic device 110 remains within short-range communications range of the electronic device 104), the electronic device 110 is provided with the ability to control the content that is being output by the electronic device 104 (e.g., via the media output device 150). While the electronic device 110 is provided with the ability to control the content that is being output by the electronic device 104, the electronic device 104 may also be able to control its own output. For example, the user of the electronic device 104 and the user of the electronic device 110 can collaborate to curate a playlist of content for output by the electronic device 104, and/or can collaborate to stop, pause, play, scrub, and/or otherwise change and/or update the content being output by the electronic device 104. During the collaborative session, the electronic device 104 may also invite one or more additional other electronic devices to join the collaborative session, and/or to control the output of the electronic device 104.

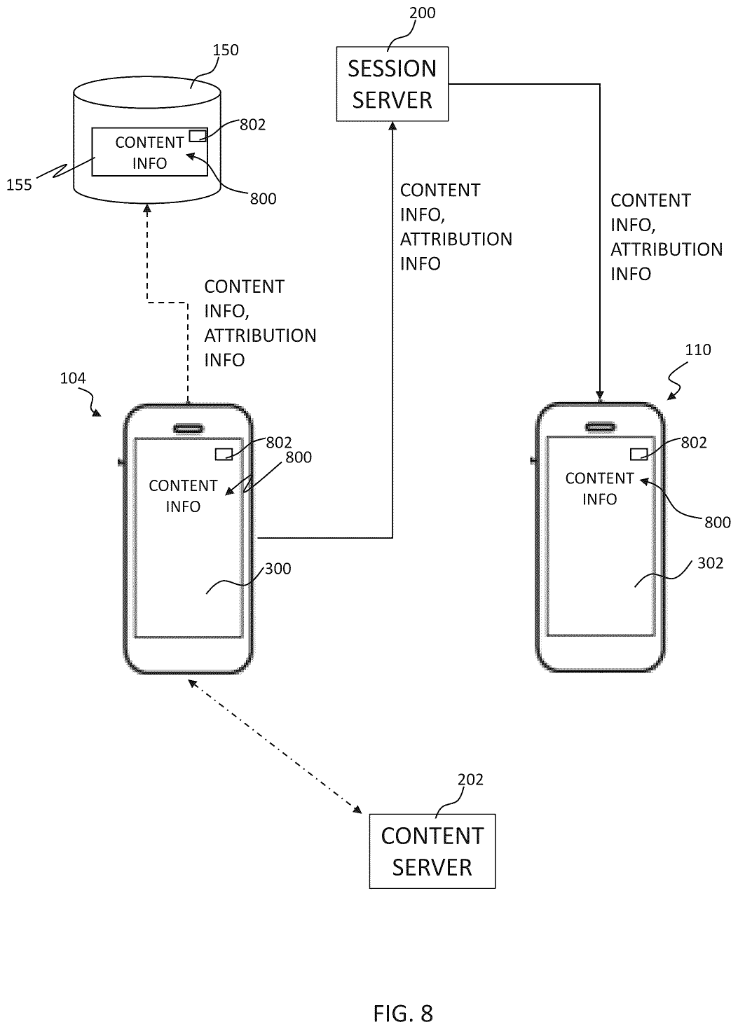

In one or more implementations, an attribution may be provided at the electronic device 104, the electronic device 110, the media output device 150, and/or one or more other electronic devices in a collaborative session, the attribution information identifying which electronic device (e.g., and/or a user thereof) selected the content currently being output by the electronic device 104. For example, FIG. 8 illustrates a use case in which, while content is being output by the electronic device 104 via the media output device 150 (e.g., by providing the content from the electronic device 104 to the media output device 150 and outputting the content with the speakers 152 and/or the display 155 of the media output device), attribution information 802 is displayed by the media output device 150. For example, in a use case in which the content currently being output by the electronic device 104 via the media output device 150 was selected at the electronic device 110 (and output by the electronic device 104 responsive to a corresponding control command from the electronic device 110, such as via the session server 200), the attribution information 802 may include (e.g., as stored in the user information 508 at the electronic device 104) a name of the user of the electronic device 110, an identifier of the electronic device 110 itself, an image of the user of the electronic device 110, an avatar of the user of the electronic device 110, and/or any other information identifying the electronic device 110 and/or the user of the electronic device 110. In this way, the user of the electronic device 104 and the user of the electronic device 110, both being in proximity to each other and the media output device 150, can view the display 155 of the media output device 150 and identify which of the users in the collaborative session selected the current content being output by the electronic device via the media output device 150.

As illustrated in FIG. 8, the media output device 150 may also display content information 800 that indicates the content currently being output at the media output device 150 by the electronic device 104. For example, the content information 800 may include a title of a song, a title of an album, a name of an artist, a title of an electronic book, a title of a podcast, a title of movie, album art, an logo, a movie poster image, a title of a series, a duration of the current content, a remaining time for playback of the current content, an indication of upcoming content, an indication of previously played content, and/or any other information describing the content being output at the media output device 150 by the electronic device 104. As shown, the content information 800 and the attribution information 802 may be provided, by the electronic device 104, to the media output device 150 for display. For example, the attribution information 802 may be obtained, by the electronic device 104, from the user information 508 for the contact 502 that is stored at the electronic device 104 for the electronic device (and/or the user of the electronic device) that selected the current content for output. The content information 800 and the attribution information 802 may be provided to the media output device 150 as metadata with the content for output, or separately from the content for output.

As shown in FIG. 8, the electronic device 104 and/or the electronic device 110 may also display the content information 800 and/or the attribution information 802. For example, the content information 800 and/or the attribution information 802 may be provided from the electronic device 104 to the electronic device 110 (e.g., and/or any other devices connected to the collaborative session), such as via the session server 200.

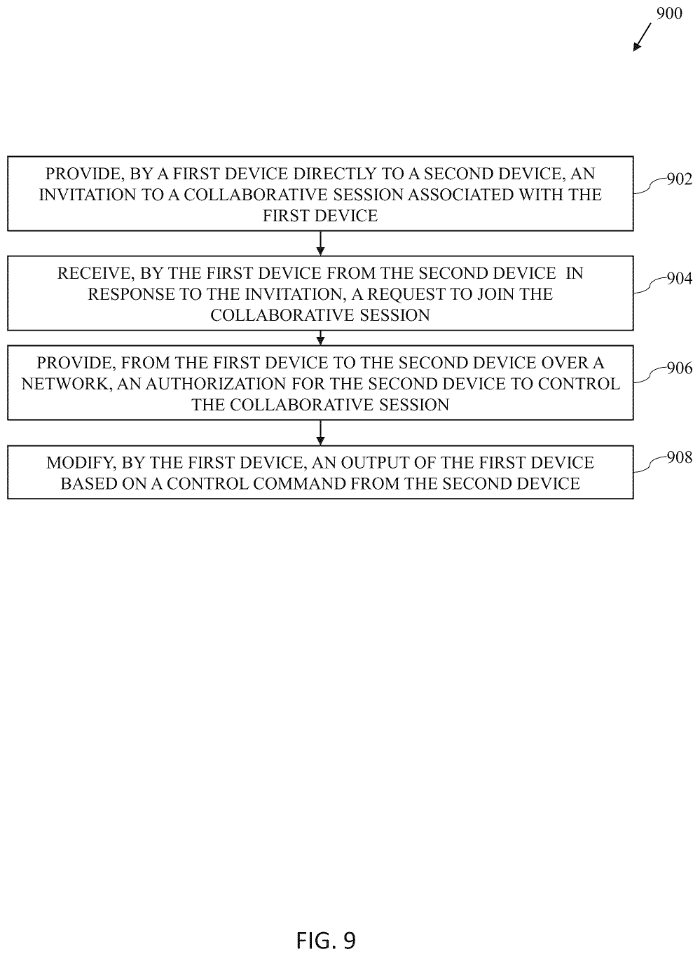

FIG. 9 illustrates a flow diagram of an example process 900 for providing nearby device invitations for electronic devices, in accordance with implementations of the subject technology. For explanatory purposes, the process 900 is primarily described herein with reference to the media output device 150, the electronic device 104, and the electronic device 110 of FIG. 1. However, the process 900 is not limited to the media output device 150, the electronic device 104, and the electronic device 110 of FIG. 1, and one or more blocks (or operations) of the process 900 may be performed by one or more other components of other suitable devices, including the electronic device 115, and/or the servers 120. Further for explanatory purposes, some of the blocks of the process 900 are described herein as occurring in serial, or linearly. However, multiple blocks of the process 900 may occur in parallel. In addition, the blocks of the process 900 need not be performed in the order shown and/or one or more blocks of the process 900 need not be performed and/or can be replaced by other operations.

As illustrated in FIG. 9, at block 902, an electronic device (e.g., electronic device 104) may provide, directly (e.g., via short-range communications, such as Bluetooth communications) to a second device (e.g., electronic device 110), an invitation to a collaborative session associated with the first device (e.g., initiated and/or controlled by the first device).

In one or more implementations, the invitation may be an encrypted invitation (e.g., encrypted for decryption by a trusted contact of the first device). The electronic device may, prior to providing the invitation, encrypt at least a portion of the invitation using a key (e.g., a key 504) previously configured by the first device and the second device. For example, the first device may configure the key responsive to identifying a contact stored, for the second device, at the first device. As another example, the first device may configure the key responsive to identifying one or more previous communications between the first device and the second device (e.g., including at least one outgoing communication from the electronic device). In one or more implementations, the encrypted invitation may include a hash of connection information (e.g., a short-range communications address) for the collaborative session and the key.

In one or more other implementations, providing the invitation may include broadcasting (e.g., using a short-range communications protocol to limit the physical distance to which the invitation is receivable) an unencrypted invitation, responsive to a user request to invite all nearby devices to the collaborative session. For example, the unencrypted invitation may include a session identifier and an obfuscated identifier for the first device.

At block 904, the first device may receive, from the second device and in response to the invitation, a request to join the collaborative session. In one or more implementations, the request may be received directly from the second device (e.g., using short-range communications, such as Bluetooth communications). In one or more implementations, the request may be received from the second device over a network (e.g., the network 106), such as via a server (e.g., the session server 200).

At block 906, the first device may provide, to the second device over the network (e.g., via a session server, such as the session server 200 described herein), an authorization for the second device to control the collaborative session. In one or more implementations, the first device may provide the authorization based, in part, on determining that the second device is within a proximity (e.g., within a range of a short-range communications protocol, and/or within an audible range) of the first device.

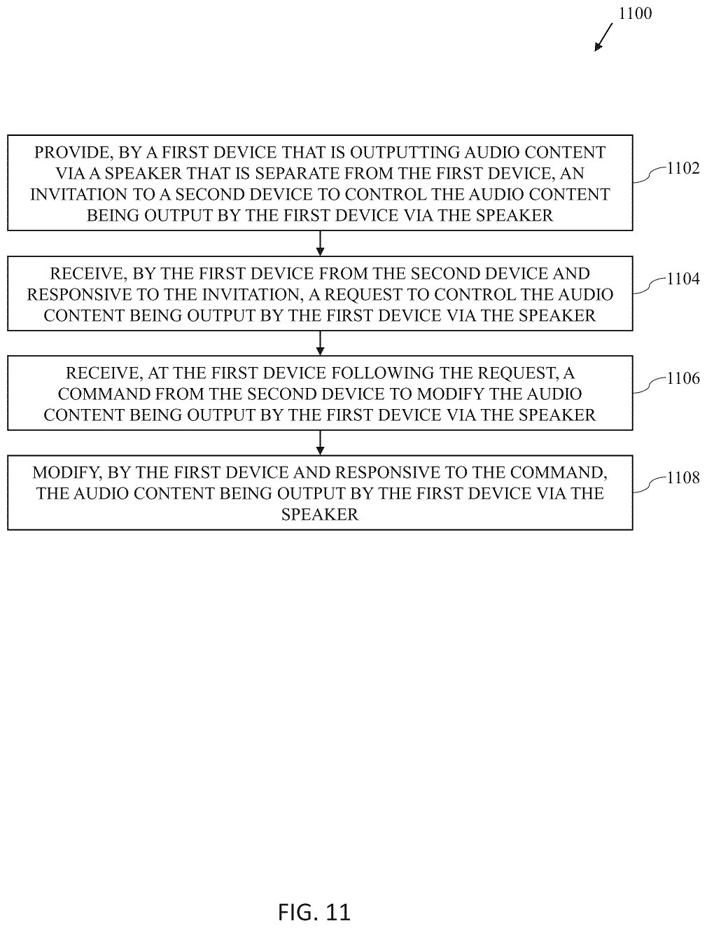

At block 908, the first device may modify an output of the first device based on a control command from the second device. The output of the first device may be output directly from the first device or output by the first device via a third device, such as the media output device 150. For example, the collaborative session may include outputting media content (e.g., audio content, video content, and/or the like), by the first device, via a third device that is separate from the first device (e.g., by sending content from the first device to the third device, for output by one or more speakers, displays, and/or other output components of the third device). In one illustrative example, the control command from the second device may include a selection of the media content (e.g., from a media library accessible using a subscription associated with the first device). As examples, the collaborative session may include any or all of: a document editing session (e.g., by multiple invited users providing control inputs to a collaborative document from their multiple respective devices), a data sharing session, a group communications session, a mapping session, a music listening session or other audio content listening session, or a video watching session. In various implementations, the collaborative session may include any or all of the operations described herein in connection with FIGS. 11 and/or 12.

In one or more implementations, the audio content may be associated with video content and the speaker may be associated with a display (e.g., display 155), such that modified audio content is part of modified video content output by the display. For example, the audio content may correspond to an audio track of the video content. For example, the video content may be a movie, an episode of a series, or any other video content being displayed on the display 155. As illustrative examples, the control command may be a command to switch to different video content (e.g., a different movie or a different episode of a series), to skip or scroll to a new portion of the video content, to pause the video content, to stop the video content, or the like.

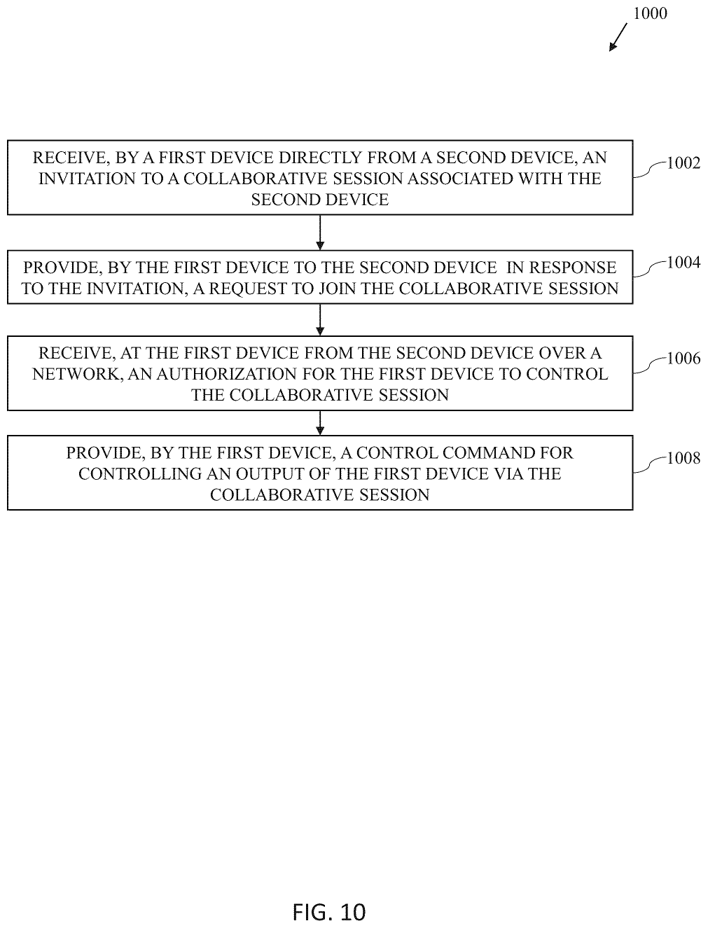

FIG. 10 illustrates a flow diagram of another example process 1000 for providing nearby device invitations for electronic devices, in accordance with implementations of the subject technology. For explanatory purposes, the process 1000 is primarily described herein with reference to the media output device 150, the electronic device 104, and the electronic device 110 of FIG. 1. However, the process 1000 is not limited to the media output device 150, the electronic device 104, and the electronic device 110 of FIG. 1, and one or more blocks (or operations) of the process 1000 may be performed by one or more other components of other suitable devices, including the electronic device 115, and/or the servers 120. Further for explanatory purposes, some of the blocks of the process 1000 are described herein as occurring in serial, or linearly. However, multiple blocks of the process 1000 may occur in parallel. In addition, the blocks of the process 1000 need not be performed in the order shown and/or one or more blocks of the process 1000 need not be performed and/or can be replaced by other operations.

As illustrated in FIG. 10, at block 1002, an electronic device (e.g., electronic device 110) may receive, directly from a second device (e.g., the electronic device 104), an invitation to a collaborative session associated with the second device. In one or more implementations, the first device may identify, based on the invitation, a contact (e.g., a contact 502) stored at the first device for the second device. For example, in one or more implementations, the invitation may include a value (e.g., a short-range communications address of the second device) and the value hashed with a key (e.g., a key 504 configured between the first device and the second device). In one or more implementations, identifying the contact may include generating local hash values at the first device by hashing the value with each of one or more respective keys (e.g., keys 504) stored at the first device in connection with one or more respective contacts (e.g., contacts 502), including the contact, stored at the first device. Identifying the contact may also include identifying the contact by identifying one of the local hash values that matches the value hashed with the key, from the invitation.

In one or more other implementations, the invitation may be an unencrypted invitation broadcast by the second device (e.g., using a short-range communications protocol), responsive to a user request to the second device to invite all nearby devices to the collaborative session. For example, the unencrypted invitation may include a session identifier and an obfuscated identifier for the second device.

At block 1004, the first device may provide, to the second device in response to the invitation, a request to join the collaborative session. In one or more implementations, the request may be provided directly to the second device (e.g., using short-range communications, such as Bluetooth communications). In one or more implementations, the request may be provided to the second device over a network (e.g., the network 106) and/or via a server (e.g., the session server 200). In one or more implementations (e.g., implementations in which the invitation is encrypted using a key), providing the request to join the collaborative session may include obtaining an identifier (e.g., in the user information 508) of the contact stored at the first device, and providing the request to join the collaborative session to a server (e.g., session server 200) along with the obtained identifier.

At block 1006, the first device may receive, from the second device an authorization for the first device to control the collaborative session. For example, the first device may receive the authorization directly from the second device, or over a network, such as the network 106.

At block 1008, the first device may provide (e.g., to the second device via a server, such as the session server 200), a control command for controlling, via the collaborative session, an output of the second device. In one or more implementations (e.g., implementations in which the invitation is encrypted using a key), providing the control command may include obtaining an identifier (e.g., in the user information 508) of the contact stored at the first device, and providing the control command to a server (e.g., session server 200) for the collaborative session along with the obtained identifier. The server may forward the control command to the second device based on the identifier (e.g., by identifying a communications address of the second deice that is stored at the first device in association with the identifier). In one or more implementations, the second device may modify the output of the second device (e.g., direct output of the second device or output via a third device, such as the media output device 150) responsive to the control command, as described herein in connection with, for example, FIGS. 3, 9, and/or 11. For example, providing the control command for controlling the output of the second device may include providing, from the first device to the second device, a selection of media content for output by the second device (e.g., via a third device, such as the media output device 150). The collaborative session may include one or more of: a media output session, a document editing session, a data sharing session, a mapping session, or a group communications session.

FIG. 11 illustrates a flow diagram of an example process 1100 for collaborative control for electronic devices, in accordance with implementations of the subject technology. For explanatory purposes, the process 1100 is primarily described herein with reference to the media output device 150, the electronic device 104, and the electronic device 110 of FIG. 1. However, the process 1100 is not limited to the media output device 150, the electronic device 104, and the electronic device 110 of FIG. 1, and one or more blocks (or operations) of the process 1100 may be performed by one or more other components of other suitable devices, including the electronic device 115, and/or the servers 120. Further for explanatory purposes, some of the blocks of the process 1100 are described herein as occurring in serial, or linearly. However, multiple blocks of the process 1100 may occur in parallel. In addition, the blocks of the process 1100 need not be performed in the order shown and/or one or more blocks of the process 1100 need not be performed and/or can be replaced by other operations.

As illustrated in FIG. 11, at block 1102, an electronic device (e.g., electronic device 104) that is outputting content (e.g., audio content) via a media output device (e.g., via a speaker, such as a speaker 152 of a media output device 150) that is separate from the first device, may provide an invitation to a second device to control the (e.g., audio) content being output by the first device via the media output device (e.g., the speaker). In one or more implementations, prior to outputting the (e.g., audio) content via the media output device (e.g., the speaker) with the first device, and prior to providing the invitation, the first device may provide a user-selectable option (e.g., user-selectable option 400 of FIG. 4) to allow or deny providing the invitation. In various implementations, the speaker may be a speaker of a vehicle, a portable speaker, or a speaker in a building.

In one or more implementations, the invitation may be free of identifying information of the first device or a user of the first device. For example, the invitation may include and/or be encrypted using a key that can be used, by a device of a trusted contact, to locally identify the first device using previously configured information, but cannot be used to identify the first device by any other device. As another example, the invitation may include an obfuscated identifier that can be used by a trusted server (e.g., session server 200) to obtain an un-obfuscated (e.g., clear) identifier of the first device, but cannot be used by any other device to derive the un-obfuscated (e.g., clear) identifier.

In one or more implementations, providing the invitation may include providing the invitation, encrypted for a trusted contact of the first device. In one or more implementations, providing the invitation may include providing a scannable code to the second device. For example, providing the scannable code may include displaying the scannable code with a display (e.g., display 300) of the first device (e.g., for scanning using a camera or other sensor of the second device).

In one or more implementations, the first device may receive (e.g., via a selection of a user-selectable option 402) a user request to invite nearby devices to control the audio content being output by the first device via the speaker, and may provide the invitation by broadcasting, from the first device using a short-range wireless communication protocol, an unencrypted invitation responsive to the user request.

At block 1104, the first device may receive, from the second device and responsive to the invitation, a request to control the (e.g., audio) content being output by the first device via the media output device (e.g., as described herein in connection with FIG. 2). In one or more implementations, responsive to the request and based in part on a determination that the second device is within a proximate range of the first device, the first device may provide an authorization for the second device to control the audio content.

At block 1106, following the request (e.g., and following the authorization by the first device), the first device may receive a command from the second device to modify the (e.g., audio) content being output by the first device via the media output device (e.g., as described herein in connection with FIG. 2). In one or more implementations, providing the invitation to the second device may include providing the invitation to the second device directly (e.g., using short-range communications, such as Bluetooth communications) from the first device, and receiving the request may include receiving the request directly (e.g., using the short-range communications, such as Bluetooth communications) from the second device.

At block 1108, the first device may modify, responsive to the command, the (e.g., audio) content being output by the first device via the media output device (e.g., as described herein in connection with FIG. 3). In one or more implementations, providing the invitation to the second device may include providing the invitation to the second device directly (e.g., using short-range communications, such as Bluetooth communications) from the first device, and receiving the control command may include receiving the control command at the first device from the second device over a network (e.g., over the network 106, such as a via a server, such as the session server 200). In one or more implementations, modifying the (e.g., audio) content may include, by the first device, obtaining different content (e.g., a new song, new episode, new movie, or the like) from a server (e.g., content server 202) and providing the different content to the media output device (e.g., the speaker) via the first device for output.

In one or more implementations, the process 1100 may also include displaying, by a display (e.g., display 155) associated with the media output device (e.g., associated with the speaker), an attribution (e.g., attribution information 802) associated with the second device, while the modified (e.g., audio) content is being output by the first device via the media output device (e.g., as described herein in connection with FIG. 8).

In one or more implementations, modifying the (e.g., audio) content being output by the first device via the media output device (e.g., speaker) may include modifying the (e.g., audio) content based, in part, on a determination (e.g., based on short-range communications and/or audio-based proximity verification) that the second device remains within the proximate range of the first device. In one or more implementations, the process 1100 may also include determining that the second device has moved away from the first device (e.g., outside of a proximal distance, such as out of range of a short-range communications protocol and/or outside of an audible range of the speaker. The first device may end control of the (e.g., audio) content by the second device responsive to determining that the second device has moved away from the first device. In one or more implementations, responsive to determining that the second device has moved away from the first device, the first device may also provide, to the second device (e.g., over the network or another network) a playlist (or other summary) associated with a portion of the (e.g., audio) content that was output by the first device via the media output device (e.g., speaker) while the second device had control of the (e.g., audio) content.

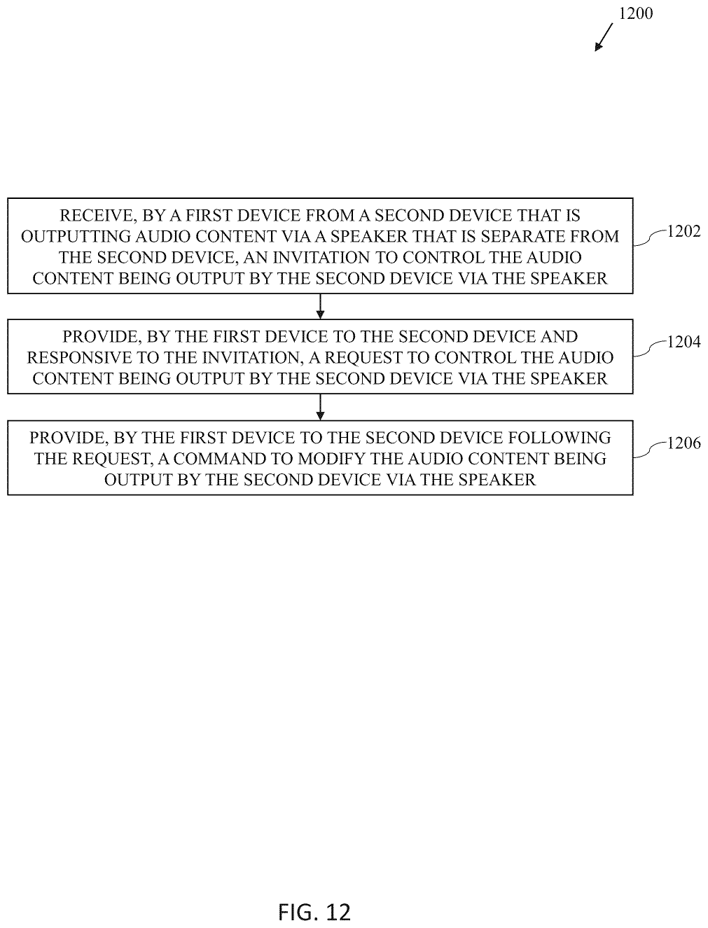

FIG. 12 illustrates a flow diagram of another example process 1200 for collaborative control for electronic devices, in accordance with implementations of the subject technology. For explanatory purposes, the process 1200 is primarily described herein with reference to the media output device 150, the electronic device 104, and the electronic device 110 of FIG. 1. However, the process 1200 is not limited to the media output device 150, the electronic device 104, and the electronic device 110 of FIG. 1, and one or more blocks (or operations) of the process 1200 may be performed by one or more other components of other suitable devices, including the electronic device 115, and/or the servers 120. Further for explanatory purposes, some of the blocks of the process 1200 are described herein as occurring in serial, or linearly. However, multiple blocks of the process 1200 may occur in parallel. In addition, the blocks of the process 1200 need not be performed in the order shown and/or one or more blocks of the process 1200 need not be performed and/or can be replaced by other operations.

As illustrated in FIG. 12, at block 1202, an electronic device (e.g., electronic device 110) may receive, from a second device (e.g., electronic device 104) that is outputting (e.g., audio) content via a media output device (e.g., speaker, such as a speaker 152 of a media output device 150) that is separate from the second device, an invitation to control the (e.g., audio) content being output by the second device via the media output device (e.g., as described herein in connection with FIG. 2).

In one or more implementations, the first device may identify, using encrypted information in the invitation, and using a key (e.g., a key 504) previously configured by the first device and the second device, a contact (e.g., a contact 502) stored at the first device in association with a user of the second device. In one or more implementations, receiving the invitation may include receiving the invitation directly (e.g., using short-range communications, such as Bluetooth communications) from the second device at the first device, and providing the request may include providing the request to the second device directly from the first device. In one or more implementations, receiving the invitation may include receiving the invitation based on a proximity of the second device to the first device (e.g., by the first device being located within range of short-range communications from the second device, and/or being within audible range of the second device and/or the media output device). In one or more implementations, the second device may be associated with a subscription to a service (e.g., provided by a server, such as the content server 202) that provides access to the content, and the first device does not have access to the service (e.g., the first device does not have, and/or is not logged into a subscription to the service).

At block 1204, the first device may provide, to the second device and responsive to the invitation, a request to control the (e.g., audio) content being output by the second device via the media output device (e.g., as described herein in connection with FIG. 2). The request may be provided directly from the first device (e.g., using a short-range communications profile) or via a network (e.g., the network 106) and/or a server (e.g., the session server 200).

At block 1206, the first device may provide, to the second device following the request, a command to modify the (e.g., audio) content being output by the first device via the media output device (e.g., as described herein in connection with FIG. 3). For example, the command may be provided to the second device over a network (e.g., the network 106) and/or a server (e.g., the session server 200).

As described above, one aspect of the present technology is the gathering and use of data available from specific and legitimate sources for nearby device invitations for electronic devices and/or collaborative control for electronic devices. The present disclosure contemplates that in some instances, this gathered data may include personal information data that uniquely identifies or can be used to identify a specific person. Such personal information data can include audio data, voice samples, voice profiles, demographic data, location-based data, online identifiers, telephone numbers, email addresses, home addresses, biometric data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used for nearby device invitations for electronic devices and/or collaborative control for electronic devices.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the example of nearby device invitations for electronic devices and/or collaborative control for electronic devices, the present technology can be configured to allow users to select to “opt in” or “opt out” of participation in the collection and/or sharing of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level or at a scale that is insufficient for facial recognition), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

FIG. 13 illustrates an electronic system 1300 with which one or more implementations of the subject technology may be implemented. The electronic system 1300 can be, and/or can be a part of, the media output device 150, the electronic device 104, the electronic device 110, the electronic device 115, and/or the server 120 as shown in FIG. 1. The electronic system 1300 may include various types of computer readable media and interfaces for various other types of computer readable media. The electronic system 1300 includes a bus 1308, one or more processing unit(s) 1312, a system memory 1304 (and/or buffer), a ROM 1310, a permanent storage device 1302, an input device interface 1314, an output device interface 1306, and one or more network interfaces 1316, or subsets and variations thereof.

The bus 1308 collectively represents all system, peripheral, and chipset buses that communicatively connect the numerous internal devices of the electronic system 1300. In one or more implementations, the bus 1308 communicatively connects the one or more processing unit(s) 1312 with the ROM 1310, the system memory 1304, and the permanent storage device 1302. From these various memory units, the one or more processing unit(s) 1312 retrieves instructions to execute and data to process in order to execute the processes of the subject disclosure. The one or more processing unit(s) 1312 can be a single processor or a multi-core processor in different implementations.

The ROM 1310 stores static data and instructions that are needed by the one or more processing unit(s) 1312 and other modules of the electronic system 1300. The permanent storage device 1302, on the other hand, may be a read-and-write memory device. The permanent storage device 1302 may be a non-volatile memory unit that stores instructions and data even when the electronic system 1300 is off. In one or more implementations, a mass-storage device (such as a magnetic or optical disk and its corresponding disk drive) may be used as the permanent storage device 1302.

In one or more implementations, a removable storage device (such as a floppy disk, flash drive, and its corresponding disk drive) may be used as the permanent storage device 1302. Like the permanent storage device 1302, the system memory 1304 may be a read-and-write memory device. However, unlike the permanent storage device 1302, the system memory 1304 may be a volatile read-and-write memory, such as random access memory. The system memory 1304 may store any of the instructions and data that one or more processing unit(s) 1312 may need at runtime. In one or more implementations, the processes of the subject disclosure are stored in the system memory 1304, the permanent storage device 1302, and/or the ROM 1310 (which are each implemented as a non-transitory computer-readable medium). From these various memory units, the one or more processing unit(s) 1312 retrieves instructions to execute and data to process in order to execute the processes of one or more implementations.

The bus 1308 also connects to the input and output device interfaces 1314 and 1306. The input device interface 1314 enables a user to communicate information and select commands to the electronic system 1300. Input devices that may be used with the input device interface 1314 may include, for example, alphanumeric keyboards and pointing devices (also called “cursor control devices”). The output device interface 1306 may enable, for example, the display of images generated by electronic system 1300. Output devices that may be used with the output device interface 1306 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 13, the bus 1308 also couples the electronic system 1300 to one or more networks and/or to one or more network nodes, through the one or more network interface(s) 1316. In this manner, the electronic system 1300 can be a part of a network of computers (such as a LAN, a wide area network (“WAN”), or an Intranet, or a network of networks, such as the Internet. Any or all components of the electronic system 1300 can be used in conjunction with the subject disclosure.

These functions described above can be implemented in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (also referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; e.g., feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; e.g., by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and may interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. The described functionality may be implemented in varying ways for each particular application. Various components and blocks may be arranged differently (e.g., arranged in a different order, or partitioned in a different way) all without departing from the scope of the subject technology.

It is understood that the specific order or hierarchy of steps in the processes disclosed is an illustration of example approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention described herein.

The predicate words “configured to”, “operable to”, and “programmed to” do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

The term automatic, as used herein, may include performance by a computer or machine without user intervention; for example, by instructions responsive to a predicate action by the computer or machine or other initiation mechanism. The word “example” is used herein to mean “serving as an example or illustration.” Any aspect or design described herein as “example” is not necessarily to be construed as preferred or advantageous over other aspects or designs.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a “configuration” may refer to one or more configurations and vice versa.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f), unless the element is expressly recited using the phrase “means for” or, in the case of a method claim, the element is recited using the phrase “step for”.

What is claimed is:

1. A method, comprising:
providing, by a first device that is outputting audio content via a speaker that is separate from the first device, an invitation to a second device to control the audio content being output by the first device via the speaker;
receiving, by the first device from the second device and responsive to the invitation, a request to control the audio content being output by the first device via the speaker;
receiving, at the first device following the request, a command from the second device to modify the audio content being output by the first device via the speaker; and
modifying, by the first device and responsive to the command, the audio content being output by the first device via the speaker.

2. The method of claim 1, wherein providing the invitation to the second device comprises providing the invitation to the second device directly from the first device, and wherein receiving the request comprises receiving the request at the first device from the second device over a network.

3. The method of claim 1, wherein the invitation is free of identifying information of the first device or a user of the first device.

4. The method of claim 3, wherein providing the invitation comprises providing the invitation, encrypted for a trusted contact of the first device, responsive to determining that the second device is within a range of a short-range wireless communication protocol communication of the first device.

5. The method of claim 3, wherein providing the invitation comprises providing a scannable code to the second device.

6. The method of claim 5, wherein providing the scannable code comprises displaying the scannable code with a display of the first device.

7. The method of claim 3, further comprising:
receiving, by the first device, a user request to invite nearby devices to control the audio content being output by the first device via the speaker; and
providing the invitation by broadcasting, from the first device using a short-range wireless communication protocol, an unencrypted invitation responsive to the user request.

8. The method of claim 1, further comprising displaying, by a display associated with the speaker, an attribution associated with the second device, while the modified audio content is being output by the first device via the speaker.

9. The method of claim 1, wherein modifying the audio content comprises, by the first device, obtaining different content from a server and providing the different content to the speaker via the first device for output.

10. The method of claim 1, further comprising, prior to outputting the audio content via the speaker with the first device, and prior to providing the invitation, providing, by the first device, a user-selectable option to allow or deny providing the invitation.

11. The method of claim 1, further comprising, by the first device:
determining that the second device has moved away from the first device; and
ending control of the audio content by the second device responsive to determining that the second device has moved away from the first device.

12. The method of claim 11, further comprising, responsive to determining that the second device has moved away from the first device, providing, to the second device a playlist associated with a portion of the audio content that was output by the first device via the speaker while the second device had control of the audio content.

13. The method of claim 1, wherein the speaker comprise a speaker of a vehicle, a portable speaker, or a speaker in a building.

14. The method of claim 1, further comprising providing, responsive to the request and based in part on a determination that the second device is within a proximate range of the first device, an authorization for the second device to control the audio content.

15. The method of claim 14, wherein modifying the audio content being output by the first device via the speaker comprises modifying the audio content based, in part, on a determination that the second device remains within the proximate range of the first device.

16. The method of claim 1, wherein the audio content is associated with video content and the speaker is associated with a display, such that modified audio content is part of modified video content output by the display.

17. A method, comprising:
receiving, by a first device from a second device that is outputting audio content via a speaker that is separate from the second device, an invitation to control the audio content being output by the second device via the speaker;
providing, by the first device to the second device and responsive to the invitation, a request to control the audio content being output by the second device via the speaker; and
providing, by the first device to the second device following the request, a command to modify the audio content being output by the first device via the speaker.

18. The method of claim 17, further comprising identifying, by the first device using encrypted information in the invitation and a key previously configured by the first device and the second device, a contact stored at the first device in association with a user of the second device.

19. The method of claim 17, wherein receiving the invitation comprises receiving the invitation directly from the second device at the first device, and wherein providing the request comprises providing the request to the second device from the first device via a network.

20. The method of claim 17, wherein receiving the invitation comprises receiving the invitation based on a proximity of the second device to the first device, wherein the second device is associated with a subscription to a service that provides access to the audio content, and wherein the first device does not have access to the service.

21. An electronic device, comprising:
a memory; and
one or more processors configured to:
provide, while outputting audio content via a speaker that is separate from the electronic device, an invitation to an other electronic device to control the audio content being output by the electronic device via the speaker;
receive, by the electronic device from the other device and responsive to the invitation, a request to control the audio content being output by the electronic device via the speaker;
receive, at the electronic device following the request, a command from the other device to modify the audio content being output by the electronic device via the speaker; and
modify, by the electronic device and responsive to the command, the audio content being output by the electronic device via the speaker.
